(19) United States
(12) Patent Application Publication
(10) Pub. No.: US 2026/0091328 A1
(43) Pub. Date: Apr. 2, 2026

(54) SUBSTRATE PROCESSING DEVICE AND METHOD FOR REMOVING BUBBLES FROM FILTER

(71) Applicant: SCREEN Holdings Co., Ltd., Kyoto (JP)

(72) Inventors: Yuya TSUCHIHASHI, Kyoto (JP); Hidekazu ISHIKAWA, Kyoto (JP); Sadamu FUJII, Kyoto (JP); Pohling THEN, Kyoto (JP); Takashi NAGAO, Kyoto (JP)

(21) Appl. No.: 19/110,422

(22) PCT Filed: Aug. 9, 2023
(86) PCT No.: PCT/JP2023/029065

§ 371 Date: Mar. 10, 2025

(30) Foreign Application Priority Data
Sep. 15, 2022 (JP) 2022-146824

(51) Int. Cl. B01D 29/66; B01D 29/60; B01D 35/143; B08B 9/032

(52) U.S. Cl. CPC B01D 29/66; B01D 29/603; B01D 35/143; B08B 9/0321; B01D 2201/167; B08B 2209/032

(57) ABSTRACT

A substrate processing apparatus is provided with a substrate processor a piping, a filter, an upstream-side piping, a downstream-side piping, and a removing liquid supply. The substrate processor processes a substrate W. The piping allows a processing liquid to flow therethrough toward the substrate processor. The filter is disposed in the piping. The upstream-side piping is connected to the piping at the upstream side of the filter. The downstream-side piping is connected to the piping at the downstream side of the filter. The removing liquid supply supplies a bubble removing liquid to one of the upstream-side piping and the downstream-side piping. The substrate processing apparatus allows the bubble removing liquid to pass from the one of the upstream-side piping and the downstream-side piping via the filter to the other of the upstream-side piping and the downstream-side piping.

### TECHNICAL FIELD

The present invention relates to a substrate processing apparatus and a method for removing bubbles from a filter.

### BACKGROUND ART

Conventionally, there is known a substrate processing apparatus which processes a substrate. The substrate processing apparatus is favorably used in manufacturing a semiconductor substrate. The substrate processing apparatus processes a substrate by using a processing liquid such as a chemical liquid. The processing liquid processes the substrate by flowing through a piping to which a filter, a valve, etc., are attached. The filter catches particles that are contained in the processing liquid which passes through the inside of the piping. As the above-described substrate processing apparatus, there is known a liquid processing apparatus which is provided with a tank for storing processing liquid and a circulation line that comes out from the tank and returns to the tank and in which the processing liquid is supplied to a liquid processing unit via the circulation line (for example, refer to Patent Literature 1). The liquid processing apparatus is provided with a filter for removing particles contained in the processing liquid. In the liquid processing apparatus disclosed in Patent Literature 1, a filter which has been used for a predetermined period of time is replaced with a new filter.

### Citation List

### Patent Literature

Patent Literature 1: Japanese Patent Application Publication No. 2015-103662

### SUMMARY OF INVENTION

### Technical Problem

Incidentally, for example, in a case where a processing liquid which contains bubbles is allowed to flow through a piping, the bubbles may accumulate in a filter. In this case, a part of the filter in contact with the bubbles is dried and the processing liquid will not pass through the dried part. Then, when the processing liquid which contains the bubbles is continuously allowed to flow through the piping, the part of the filter in contact with the bubbles is increased, thus resulting in a failure of securing a flow rate of the processing liquid which flows through the piping. Therefore, the filter is required to be replaced with a new filter.

However, since replacement of the filter leads to an increase in environmental load, in view of a reduction in environmental load, it is desirable to reduce the frequency of replacing the filter.

The present invention has been made in view of the above problem, an object of which is to provide a substrate processing apparatus capable of reducing the frequency of replacing a filter and a method for removing bubbles from a filter.

### Solution to Problem

According to an aspect of the present invention, the substrate processing apparatus is provided with a substrate processing unit, a processing liquid piping, a filter, an upstream-side piping, a downstream-side piping and a removing liquid supplying portion. The substrate processing unit processes a substrate. The processing liquid piping allows to flow a processing liquid therethrough toward the substrate processing unit. The filter is disposed in the processing liquid piping. The upstream-side piping is connected to the processing liquid piping at an upstream side of the filter. The downstream-side piping is connected to the processing liquid piping at downstream side of the filter. The removing liquid supplying portion is connected to one of the upstream-side piping and the downstream-side piping. The removing liquid supplying portion supplies a bubble removing liquid for removing bubbles clogging the filter to the one of the upstream-side piping and the downstream-side piping. The substrate processing apparatus allows the bubble removing liquid to pass from the one of the upstream-side piping and the downstream-side piping via the filter to the other of the upstream-side piping and the downstream-side piping.

In a preferred embodiment, the substrate processing apparatus is further provided with a cleaning piping and a cleaning liquid supplying portion. The cleaning piping is connected to the processing liquid piping at the upstream side or the downstream side of the filter. The cleaning liquid supplying portion is connected to the cleaning piping. The cleaning liquid supplying portion supplies a cleaning liquid for washing away the processing liquid to the cleaning piping. The substrate processing apparatus allows the cleaning liquid to pass from the cleaning piping via the filter to the other of the upstream-side piping and the downstream-side piping.

In a preferred embodiment, the substrate processing apparatus is further provided with a first valve, a second valve, a third valve, a fourth valve and a fifth valve. The first valve is disposed in the processing liquid piping at the upstream side of the filter. The second valve is disposed in the processing liquid piping at the downstream side of the filter. The third valve is disposed in the upstream-side piping. The fourth valve is disposed in the downstream-side piping. The fifth valve is disposed in the cleaning piping. The substrate processing apparatus allows the processing liquid to pass from the upstream side of the processing liquid piping via the filter to the downstream side of the processing liquid piping by closing the third valve, the fourth valve, and the fifth valve and opening the first valve and the second valve. The substrate processing apparatus allows the bubble removing liquid to pass from the one of the upstream-side piping and the downstream-side piping via the filter to the other of the upstream-side piping and the downstream-side piping by closing the first valve, the second valve, and the fifth valve and opening the third valve and the fourth valve. The substrate processing apparatus allows the cleaning liquid to pass from the cleaning piping via the filter to the other of the upstream-side piping and the downstream-side piping by closing the first valve and the second valve as well as one of the third valve and the fourth valve and opening the other of the third valve and the fourth valve as well as the fifth valve.

In a preferred embodiment, the substrate processing apparatus is further provided with a flow meter which is disposed in the processing liquid piping and measures a flow rate of a processing liquid which passes through the filter. In a case where a measured value of the flow meter is less than a threshold, the substrate processing apparatus allows the bubble removing liquid to pass from the one of the upstream-side piping and the downstream-side piping via the filter to the other of the upstream-side piping and the downstream-side piping.

In a preferred embodiment, the substrate processing apparatus allows the bubble removing liquid to pass s from the one of the upstream-side piping and the downstream-side piping via the filter to the other of the upstream-side piping and the downstream-side piping on a regular basis.

In a preferred embodiment, the substrate processing apparatus is further provided with a flow meter for measuring a flow rate of a liquid which passes through the filter. After the substrate processing apparatus allows the bubble removing liquid to pass from the one of the upstream-side piping and the downstream-side piping via the filter to the other of the upstream-side piping and the downstream-side piping, in a case where a measured value of the flow meter is less than a predetermined value, the substrate processing again allows the bubble removing liquid to pass from the one of the upstream-side piping and the downstream-side piping via the filter to the other of the upstream-side piping and the downstream-side piping.

According to another aspect of the present invention, the method for removing bubbles from a filter includes a processing liquid flowing step or feeding a processing liquid for processing a substrate to a filter disposed in a processing liquid piping which leads to a substrate processing unit and a removing liquid flowing step of allowing a bubble removing liquid for removing bubbles which are clogging the filter to pass from one of an upstream-side piping which is connected to the processing liquid piping at an upstream side of the filter and a downstream-side piping which is connected to the processing liquid piping at a downstream side of the filter via the filter to the other of the upstream-side piping and the downstream-side piping.

In a preferred embodiment, the method for removing bubbles from a filter may further include, prior to the removing liquid flowing step, a cleaning liquid flowing step of allowing a cleaning liquid for washing away the processing liquid to pass from a cleaning piping which is connected to the processing liquid piping at the upstream side or the downstream side of the filter via the filter to the other of the upstream-side piping and the downstream-side piping.

In a preferred embodiment, a flow rate of a processing liquid which passes through the filter is measured in the processing liquid flowing step, and in a case where the flow rate of the processing liquid is less than a threshold, the removing liquid flowing step may be executed.

In a preferred embodiment, the removing liquid flowing step may be executed on a regular basis.

In a a preferred embodiment, the method for removing bubbles from a filter further includes, after the removing liquid flowing step, a measurement step of measuring a flow rate of a liquid which passes through the filter, and in a case where a measured value of the flow meter is less than a predetermined value, the removing liquid flowing step may be executed again.

### Advantageous Effects of Invention

According to the present invention, there can be provided a substrate processing apparatus capable of reducing the frequency of replacing a filter and a method for removing bubbles from a filter.

### BRIEF DESCRIPTION OF DRAWINGS

FIG. 1 is a schematic plan view of a substrate processing apparatus of a first preferred embodiment.

FIG. 2 is a schematic diagram of a substrate processing unit in the substrate processing apparatus of the first preferred embodiment.

FIG. 3 is a schematic diagram for describing a piping configuration in the substrate processing apparatus of the first preferred embodiment.

FIG. 4 is a block diagram of the substrate processing apparatus of the first preferred embodiment.

FIG. 5 is a flow chart which shows a method for removing bubbles from a filter of the first preferred embodiment.

FIG. 6A is a schematic diagram for describing the method for removing bubbles of the first preferred embodiment as well as a drawing in which a flow of a liquid around a filter unit is indicated with arrows.

FIG. 6B is a schematic diagram for describing the method for removing bubbles of the first preferred embodiment as well as a drawing in which a flow of a liquid around a filter unit is indicated with arrows.

FIG. 6C is a schematic diagram for describing the method for removing bubbles of the first preferred embodiment as well as a drawing in which a flow of a liquid around a filter unit is indicated with arrows.

FIG. 7 is a schematic diagram for describing a piping configuration in a substrate processing apparatus of a second preferred embodiment.

FIG. 8 is a flow chart which shows a method for removing bubbles from a filter of the second preferred embodiment.

FIG. 9A is a schematic diagram for describing the method for removing bubbles of the second preferred embodiment as well as a drawing in which a flow of a liquid around a filter unit is indicated with arrows.

FIG. 9B is a schematic diagram for describing the method for removing bubbles of the second preferred embodiment as well as a drawing in which a flow of a liquid around a filter unit is indicated with arrows.

FIG. 9C is a schematic diagram for describing the method for removing bubbles of the second preferred embodiment as well as a drawing in which a flow of a liquid around a filter unit is indicated with arrows.

FIG. 10 is a schematic diagram for describing a piping configuration in a substrate processing apparatus of a first modified example.

FIG. 11 is a schematic diagram for describing a piping configuration in a substrate processing apparatus of a second modified example.

FIG. 12 is a flow chart which shows a method for removing bubbles from a filter of a third preferred embodiment.

FIG. 13 is a flow chart which shows a method for removing bubbles from a filter of a fourth preferred embodiment.

FIG. 14 is a flow chart which shows a method for removing bubbles from a filter of a fifth preferred embodiment.

FIG. 15 is a schematic diagram for describing a piping configuration in a substrate processing apparatus of a sixth preferred embodiment.

FIG. 16 is a flow chart which shows a method for removing bubbles from a filter of a seventh preferred embodiment.

FIG. 17 is a schematic diagram for describing a method for removing bubbles of a seventh preferred embodiment as well as a drawing in which a flow of a liquid around a filter unit is indicated with arrows.

### DESCRIPTION OF EMBODIMENTS

Hereinafter, the preferred embodiments of the substrate processing apparatus and the method for removing bubbles from a filter according to the present invention will be described with reference to the drawings. In the drawings, the same or corresponding parts are provided with the same reference signs and the description will not be repeated. In the specification of the present application, an X axis, a Y axis and a Z axis which are orthogonal to each other may be described for facilitating understanding of the invention. In the present preferred embodiments, the X axis and the Y axis are parallel in a horizontal direction, and the Z axis is parallel in a vertical direction.

### First Preferred Embodiment

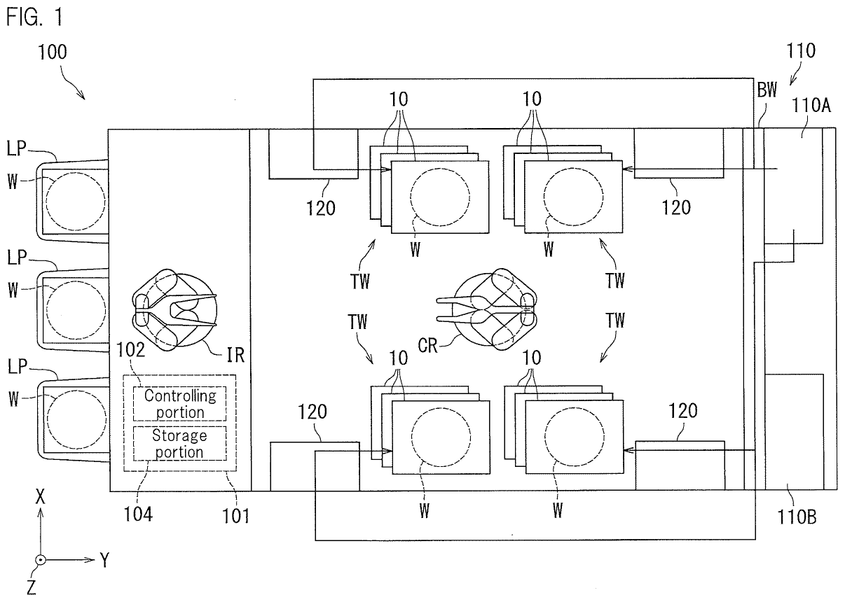

With reference to FIG. 1 to FIG. 5 and FIG. 6A to FIG. 6C, a description will be given of a substrate processing apparatus 100 according to a first preferred embodiment of the present invention. FIG. 1 is a schematic plan view of the substrate processing apparatus 100 of the first preferred embodiment.

The substrate processing apparatus 100 processes a substrate W. The substrate processing apparatus 100 processes the substrate W such that at least one among etching, surface processing, characteristics imparting, processing film forming, removing of at least a portion of a film, and cleaning is performed on the substrate W.

The substrate W is used as a semiconductor substrate. The substrate W includes a semiconductor wafer. The substrate W is, for example, substantially in a disk shape. Here, the substrate processing apparatus 100 processes the substrate W one by one.

As shown in FIG. 1, the substrate processing apparatus 100 is provided with a plurality of substrate processing units 10, a processing liquid cabinet 110, a processing liquid box 120, a plurality of load ports LP, an indexer robot IR, a center robot CR, and a controller 101. The controller 101 controls the load port LP, the indexer robot IR, and the center robot CR. The controller 101 includes a controlling portion 102 and a storage portion 104.

Each of the load ports LP houses plural sheets of the substrates W by stacking them. The indexer robot IR transfers the substrate W between the load port LP and the center robot CR. The center robot CR transfers the substrate W between the indexer robot IR and the substrate processing unit 10. Each of the substrate processing units 10 discharges a processing liquid to the substrate W and processes the substrate W. The processing liquid includes, for example, a chemical liquid, a cleaning liquid, a removing liquid, and/or a water repellent. The processing liquid cabinet 110 houses the processing liquid. It is noted that the processing liquid cabinet 110 may house a gas.

Specifically, a plurality of the substrate processing units 10 form a plurality of towers TW (in FIG. 1, four towers TW) which are disposed such as to surround the center robot CR in a plan view. Each of the towers TW includes the plurality of substrate processing units 10 (in FIG. 1, three substrate processing units 10) which are stacked in an up/down direction. The processing liquid boxes 120 each correspond to the plurality of towers TW. A liquid inside the processing liquid cabinet 110 is supplied via any one of the processing liquid boxes 120 to all of the substrate processing units 10 which are included in the towers TW corresponding to the processing liquid boxes 120. Also, a gas inside the processing liquid cabinet 110 is also supplied via any one of the processing liquid boxes 120 to all of the substrate processing units 10 which are included in the towers TW corresponding to the processing liquid boxes 120.

In the substrate processing apparatus 100, a border wall BW is disposed between a region in which the center robot CR and the substrate processing unit 10 are installed and a region in which the processing liquid cabinet 110 is installed. The processing liquid cabinet 110 demarcates a certain space of a region of the substrate processing apparatus 100 which is an outer portion of the border wall BW.

Typically, the processing liquid cabinet 110 has a preparation tank (tank) for preparing a processing liquid. The processing liquid cabinet 110 may have a preparation tank for a single type of the processing liquid or may have a preparation tank for plural types of the processing liquids. Also, the processing liquid cabinet 110 has a pump, a nozzle, and/or a filter for allowing the processing liquid to flow.

Here, the processing liquid cabinet 110 has a first processing liquid cabinet 110A and a second processing liquid cabinet 110B. The first processing liquid cabinet 110A and the second processing liquid cabinet 110B are disposed to oppose each other.

The controller 101 controls various types of operations of the substrate processing apparatus 100.

The controller 101 includes the controlling portion 102 and the storage portion 104. The controlling portion 102 has a processor. The controlling portion 102 has, for example, a central processing unit (CPU). Alternatively, the controlling portion 102 may have a general-purpose computation machine.

The storage portion 104 stores data and a computer program. The data includes recipe data. The recipe data includes information which shows a plurality of recipes. Each of the plurality of the recipes regulate processing contents and processing procedures of a substrate W.

The storage portion 104 includes a main storage and an auxiliary storage. The main storage is, for example, a semiconductor memory. The auxiliary storage is, for example, a semiconductor memory, and/or a hard disk drive. The storage portion 104 may include a removable memory. The controlling portion 102 executes computer programs which are stored in the storage portion 104 and executes a substrate processing operation.

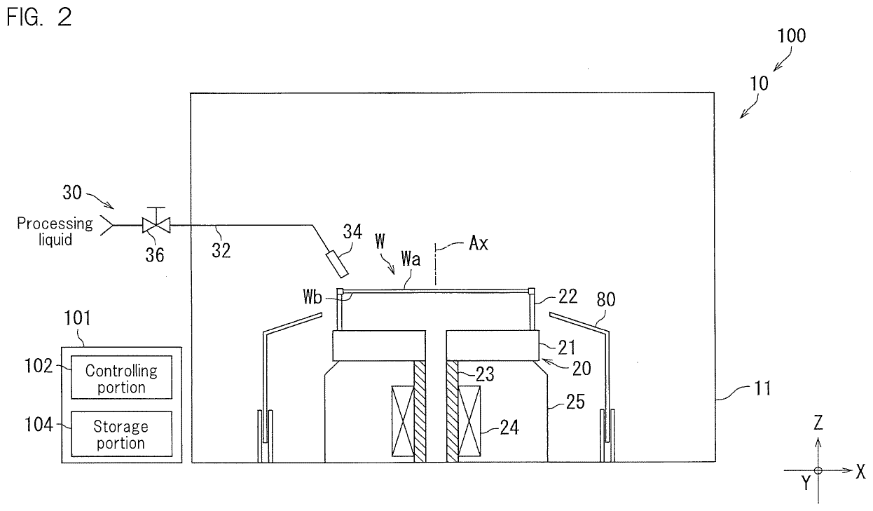

Next, with reference to FIG. 2, a description will be given of the substrate processing unit 10 in the substrate processing apparatus 100 of the first preferred embodiment. FIG. 2 is a schematic diagram of the substrate processing unit 10 in the substrate processing apparatus 100 of the first preferred embodiment.

The substrate processing unit 10 is provided with a chamber 11, a substrate holding portion 20, and a processing liquid supplying portion 30.

The chamber 11 is substantially of a box shape having an inner space. The chamber 11 houses a substrate W. Here, the substrate processing apparatus 100 is of a single substrate processing type which processes the substrates W one by one, and the substrates W are housed one each in the chamber 11. The substrate W is housed inside the chamber 11 and processed inside the chamber 11. At least a part of the substrate holding portion 20 and that of the processing liquid supplying portion 30 are each housed in the chamber 11.

The substrate holding portion 20 holds the substrate W. The substrate holding portion 20 holds the substrate W horizontally so that an upper surface (front surface) Wa of the substrate W is faced upward and a rear surface (lower surface) Wb of the substrate W is faced vertically downward. Also, the substrate holding portion 20 rotates the substrate W in a state where the substrate W is held. For example, a laminated structure having a recess is provided in the upper surface Wa of the substrate W. The substrate holding portion 20 rotates the substrate W while holding the substrate W.

For example, the substrate holding portion 20 may be of a clamping type which clamps an end portion of the substrate W. Alternatively, the substrate holding portion 20 may have any arbitrary mechanism which holds the substrate W from the rear surface Wb. For example, the substrate holding portion 20 may be of a vacuum type. In this case, the substrate holding portion 20 holds the substrate W horizontally by suctioning a central portion of the rear surface Wb of the substrate W, which is a non-device-forming surface, onto the upper surface. Alternatively, the substrate holding portion 20 may be a combination of the clamping type which brings a plurality of chuck pins into contact with a circumferential end surface of the substrate W and the vacuum type.

For example, the substrate holding portion 20 includes a spin base 21, a chuck member 22, a shaft 23, an electric motor 24 and a housing 25. The chuck member 22 is provided in the spin base 21. The chuck member 22 chucks the substrate W. Typically, a plurality of the chuck members 22 are provided in the spin base 21.

The shaft 23 is a hollow shaft. The shaft 23 extends along a rotation axis Ax in a vertical direction. The spin base 21 is joined to an upper end of the shaft 23. The substrate W is placed above the spin base 21.

The spin base 21 is of a disk shape and supports the substrate W horizontally. The shaft 23 extends downward from a central portion of the spin base 21. The electric motor 24 imparts a rotation force to the shaft 23. The electric motor 24 rotates the substrate W and the spin base 21 centering about the axis of rotation Ax by rotating the shaft 23 in a rotation direction, thereby. The housing 25 surrounds the peripheries of the shaft 23 and the electric motor 24.

The processing liquid supplying portion 30 supplies a processing liquid to the substrate W. Typically, the processing liquid supplying portion 30 supplies the processing liquid to the upper surface Wa of the substrate W. At least a part of the processing liquid supplying portion 30 is housed inside the chamber 11.

The processing liquid supplying portion 30 supplies a processing liquid to the upper surface Wa of the substrate W. The processing liquid may include a so-called chemical liquid. The chemical liquid contains, for example, hydrofluoric acid. For example, hydrofluoric acid may be heated to 40° C. or higher and at 70° C. or lower or may be heated to 50° C. or higher and 60° C. or lower. However, hydrofluoric acid is not necessarily heated. Also, the chemical liquid also contains water or phosphoric acid.

Further, the chemical liquid may contain hydrogen peroxide water. Also, the chemical liquid may contain SC1 (a mixture liquid of ammonia and hydrogen peroxide water), SC2 (a mixture liquid of hydrochloric acid and hydrogen peroxide water), or aqua regia (a mixture of concentrated hydrochloric acid and concentrated nitric acid).

Alternatively, the processing liquid may contain a so-called cleaning liquid (rinse liquid). For example, the cleaning liquid may contain any one of deionized water (DIW), carbonated water, electrolyzed ion water, ozone water, ammonia water, hydrochloric acid solution with a diluted concentration (for example, about 10 ppm to 100 ppm) and reduced water (hydrogen water).

The processing liquid supplying portion 30 includes a piping 32, a nozzle 34, and a valve 36. It is noted that the piping 32 is an example of the “processing liquid piping” of the present invention. The nozzle 34 discharges the processing liquid to the upper surface Wa of the substrate W. The nozzle 34 is connected to the piping 32. The processing liquid is supplied from a supply source to the piping 32. The valve 36 opens and closes a flow channel inside the piping 32. The nozzle 34 is preferably configured to be movable with respect to the substrate W.

The valve 36 opens and closes the flow channel inside the piping 32. The valve 36 regulates a flow rate of the processing liquid which is supplied to the piping 32 by adjusting an opening degree of the piping 32. Specifically, the valve 36 includes a valve body (not shown) with a valve seat provided therein, a valve element which opens/closes the valve seat, and an actuator (not shown) which moves the valve element between an open position and a closed position.

The nozzle 34 may be movable. The nozzle 34 is able to move in a horizontal direction and/or in a vertical direction according to a movement mechanism controlled by the controlling portion 102. It is noted that in the present specification, the movement mechanism is omitted in order to avoid overly complicated drawings.

The substrate processing unit 10 is further provided with a cup 80. The cup 80 collects the processing liquid which has been scattered from the substrate W. The cup 80 elevates and lowers. For example, the cup 80 elevates vertically upward to the side of the substrate W during a period of time while the processing liquid supplying portion 30 supplies the processing liquid to the substrate W. In this case, the cup 80 collects the processing liquid scattered from the substrate W by rotation of the substrate W. Also, the cup 80 lowers vertically downward from the side of the substrate W when a period of time in which the processing liquid supplying portion 30 supplies the processing liquid to the substrate W ends.

As described above, the controller 101 includes the controlling portion 102 and the storage portion 104. The controlling portion 102 controls the substrate holding portion 20, the processing liquid supplying portion 30, and/or the cup 80. In one example, the controlling portion 102 controls the electric motor 24, the valve 36, and/or the cup 80.

The substrate processing apparatus 100 of the present preferred embodiment is favorably used in manufacturing a semiconductor element in which a semiconductor is provided. Typically, in the semiconductor element, a conductive layer and an insulating layer are laminated on a base material. The substrate processing apparatus 100 is favorably used, in manufacturing the semiconductor element, in cleaning and/or processing (for example, etching, change in characteristics, etc.) a conductive layer and/or an insulating layer.

It is noted that in the substrate processing unit 10 shown in FIG. 2, the processing liquid supplying portion 30 is able to supply one type of processing liquid. However, the present preferred embodiment is not limited thereto. The processing liquid supplying portion 30 may supply plural types of the processing liquids. For example, the processing liquid supplying portion 30 may be capable of sequentially supplying the plural types of processing liquids different in usage to the substrate W. Alternatively, the processing liquid supplying portion 30 may be capable of simultaneously supplying the plural types of processing liquids different in usage to the substrate W.

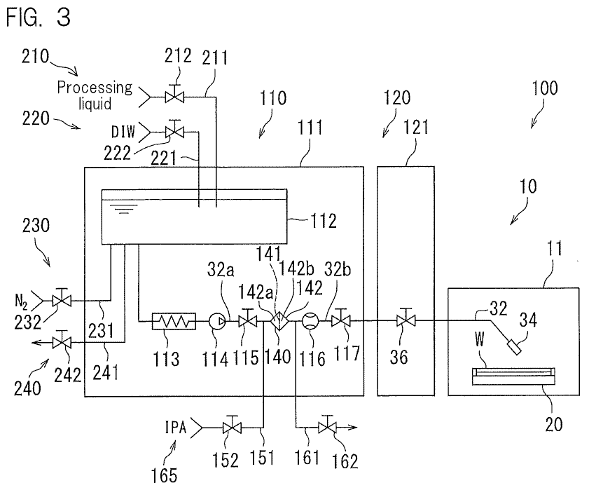

Next, with reference to FIG. 1 to FIG. 3, a description will be given of a piping configuration in the substrate processing apparatus 100 of the first preferred embodiment. FIG. 3 is a schematic diagram for describing the piping configuration in the substrate processing apparatus 100 of the first preferred embodiment. As can be understood from FIG. 1 and FIG. 2, the substrate processing apparatus 100 preferably has the plurality of substrate processing units 10, and the substrate W can preferably be processed by the plural types of processing liquids. However, here, a description will be given of a mode in which one type of the processing liquid is supplied to one substrate processing unit 10 in order to avoid an overly complicated description.

As shown in FIG. 3, the substrate processing apparatus 100 is provided with a preparation tank 112, a heater 113, a pump 114, a valve 115, a filter unit 140, a flow meter 116, and a valve 117. It is noted that the valve 115 is an example of a “first valve” of the present invention. The valve 117 is an example of a “second valve” of the present invention.

The preparation tank 112 stores the processing liquid. The processing liquid is supplied to the substrate processing unit 10 and processes the substrate W. Typically, the processing liquid is a chemical liquid. Although not particularly restricted, the processing liquid is, for example, an alkaline chemical liquid. In the first preferred embodiment, the processing liquid is an effervescent chemical liquid which contains a surfactant. Also, in the first preferred embodiment, the processing liquid is, for example, TMAH (tetramethylammonium hydroxide). It is noted that the processing liquid may contain, for example, TEAOH (tetraethylammonium hydroxide) or citric acid. Also, the processing liquid may be a cleaning liquid. The processing liquid is prepared in the preparation tank 112. Typically, the preparation tank 112 is disposed in the processing liquid cabinet 110.

The piping 32 communicatively connects the preparation tank 112 and the substrate processing unit 10. To the piping 32, the heater 113, the pump 114, the valve 115, the filter unit 140, the flow meter 116, the valve 117, and the valve 36 are attached. The processing liquid supplying portion 30 is configured of the heater 113, the pump 114, the valve 115, the filter unit 140, the flow meter 116, the valve 117, and the valve 36. It is noted that, although only one valve 36 is depicted in FIG. 3, the valve 36 is provided in each nozzle 34. Therefore, a plurality of the valves 36 are disposed in relation to one filter unit 140.

The processing liquid cabinet 110 has a cabinet 111. Typically, the preparation tank 112, the heater 113, the pump 114, the valve 115, the filter unit 140, the flow meter 116, and the valve 117 are housed inside the cabinet 111.

The processing liquid box 120 has a cabinet 121. Typically, the valve 36 is housed in the cabinet 121.

The piping 32 passes through the processing liquid box 120 from the processing liquid cabinet 110 and extends to the substrate processing unit 10. The processing liquid is prepared in the preparation tank 112 and thereafter flows from the preparation tank 112 through the piping 32 to the substrate processing unit 10. For example, the piping 32 is formed of a resin.

The heater 113 heats a liquid which passes through the piping 32. In the first preferred embodiment, the heater 113 heats the processing liquid which passes through the piping 32 to a predetermined temperature.

The pump 114 sends the processing liquid of the preparation tank 112 toward the nozzle 34.

The valve 115 is connected to the piping 32 at the upstream side of a filter 141 which will be described later. The valve 115 opens and closes a flow channel inside the piping 32. In detail, the valve 115 opens and closes a flow channel of an upstream portion 32a which is further at the upstream side of the piping 32 than the filter unit 140. The valve 115 adjusts an opening degree of the piping 32 and regulates a flow rate of the processing liquid which is supplied to the piping 32. Specifically, the valve 115 includes a valve body (not shown) with a valve seat provided therein, a valve element which opens/closes the valve seat, and an actuator (not shown) which moves the valve element between an open position and a closed position.

The filter unit 140 is attached to the piping 32. The filter unit 140 can be attached to and detached from the piping 32. In a case where the filter unit 140 is attached to the piping 32, the processing liquid flows through the filter unit 140. On the other hand, the filter unit 140 can be detached from the piping 32. Therefore, when the filter unit 140 deteriorates, the filter unit 140 is replaced.

The filter unit 140 is formed of, for example, a resin. Typically, the filter unit 140 is formed by a resin molding. In an example, the filter unit 140 is manufactured by cutting a resin molded product by using a metal cutting tool. It is noted that the filter unit 140 may be formed of a metal.

The filter unit 140 filters the processing liquid flowing through the piping 32. The filter unit 140 includes the filter 141 and a filter housing 142. The filter 141 is disposed in the piping 32. The filter 141 is formed, for example, of a porous shape. The filter 141 allows a liquid component of the processing liquid to pass through. On the other hand, the filter 141 catches particles which are contained in the processing liquid. Also, the filter 141 catches some of bubbles which are contained in the processing liquid. In other words, some of the bubbles contained in the processing liquid will not pass through the filter 141.

The filter housing 142 houses the filter 141. The filter housing 142 has an upstream chamber 142a which is disposed at the upstream side of the filter 141 and a downstream chamber 142b which is disposed at the downstream side of the filter 141. It is noted that the upstream chamber 142a and the downstream chamber 142b may be connected with a ventilation pipe for draining a gas to the outside and a drain pipe for draining a liquid to the outside. However, even in a case where the ventilation pipe is connected with the upstream chamber 142a, for example, as will be described later, in a case where many bubbles are contained in the processing liquid of the preparation tank 112, it is impossible to sufficiently drain the gas via the ventilation pipe. Therefore, bubbles accumulate in the filter 141 as will be described later.

The flow meter 116 measures a flow rate of a liquid which passes through the piping 32.

The valve 117 is disposed in the piping 32 at the downstream side of the filter 141. The valve 117 opens and closes a flow channel inside the piping 32. In detail, the valve 117 opens and closes a flow channel of a downstream portion 32b which is further at the downstream side of the piping 32 than the filter unit 140. The valve 117 adjusts an opening degree of the piping 32 and regulates a flow rate of the processing liquid which passes through the piping 32. Specifically, the valve 117 includes a valve body (not shown) with a valve seat provided therein, a valve element which opens/closes the valve seat, and an actuator (not shown) which moves the valve element between an open position and a closed position.

The substrate processing apparatus 100 is provided with a processing liquid replenishing portion 210 which supplies the processing liquid to the preparation tank 112. The processing liquid replenishing portion 210 includes a piping 211 and a valve 212. The processing liquid is supplied from a supply source to the piping 211. The valve 212 adjusts an opening degree of a flow channel inside the piping 211 and regulates a flow rate of the processing liquid which is replenished to the piping 211. Specifically, the valve 212 includes a valve body (not shown) with a valve seat provided therein, a valve element which opens/closes the valve seat, and an actuator (not shown) which moves the valve element between an open position and a closed position.

In the first preferred embodiment, the substrate processing apparatus 100 is provided with a cleaning liquid supplying portion 220 which supplies a cleaning liquid to the preparation tank 112. The cleaning liquid supplying portion 220 includes a piping 221 and a valve 222. The cleaning liquid is supplied from a supply source to the source the piping 221. The cleaning liquid which is supplied by the cleaning liquid supplying portion 220 is, for example, deionized water (DIW). The valve 222 adjusts an opening degree of a flow channel inside the piping 221 and regulates a flow rate of the cleaning liquid which is supplied to the piping 221. Specifically, the valve 222 includes a valve body (not shown) with a valve seat provided therein, a valve element which opens/closes the valve seat, and an actuator (not shown) which moves the valve element between an open position and a closed position.

Also, in the first preferred embodiment, the substrate processing apparatus 100 is provided with a gas supplying portion 230 which supplies a gas to the preparation tank 112. The gas supplying portion 230 includes a piping 231 and a valve 232. The piping 231 is, for example, connected to a lower surface of the preparation tank 112. A gas is supplied from a supply source to the piping 231. In the first preferred embodiment, the gas which is supplied by the gas supplying portion 230 is, for example, N₂ gas. It is noted that the gas supplied by the gas supplying portion 230 may be, for example, air. The valve 232 adjusts an opening degree of a flow channel inside the piping 231 and regulates a flow rate of the gas supplied to the piping 231. Specifically, the valve 232 includes a valve body (not shown) with a valve seat provided therein, a valve element which opens/closes the valve seat, and an actuator (not shown) which moves the valve element between an open position and a closed position.

By supplying the gas from the gas supplying portion 230 to the preparation tank 112, it is possible to decrease oxygen dissolved in the processing liquid. It is noted that when the gas is supplied from the gas supplying portion 230 to the preparation tank 112, bubbles are generated inside the processing liquid.

Also, in the first preferred embodiment, the substrate processing apparatus 100 is provided with a liquid draining portion 240 which drains a liquid from the preparation tank 112. The liquid draining portion 240 includes a piping 241 and a valve 242. The piping 241 is connected, for example, to a lower surface the preparation tank 112. The valve 242 adjusts an opening degree of a flow channel inside the piping 241 and regulates a flow rate of a liquid which is drained from the piping 241. Specifically, the valve 242 includes a valve body (not shown) with a valve seat provided therein, a valve element which opens/closes the valve seat, and an actuator (not shown) which moves the valve element between an open position and a closed position.

The substrate processing apparatus 100 will be described by continuing to refer to FIG. 3. The substrate processing apparatus 100 is provided with a upstream-side piping 151 and a downstream-side piping 161.

The upstream-side piping 151 is connected to the piping 32 at the upstream side of the filter 141. The upstream-side piping 151 is connected to the upstream portion 32a of the piping 32 at the upstream side of the filter 141. In the first preferred embodiment, the upstream-side piping 151 is directly connected to the piping 32. In other words, the upstream-side piping 151 is connected to the piping 32 without passing through the filter unit 140.

The downstream-side piping 161 is connected to the piping 32 at the downstream side of the filter 141. The downstream-side piping 161 is connected to the downstream portion 32b of the piping 32 at the downstream side of the filter 141. In the first preferred embodiment, the downstream-side piping 161 is directly connected to the piping 32. In other words, the downstream-side piping 161 is connected to the piping 32 without passing through the filter unit 140.

The substrate processing apparatus 100 is provided with a valve 152 and a valve 162. The valve 152 is disposed in the upstream-side piping 151. The valve 152 adjusts an opening degree of a flow channel inside the upstream-side piping 151 and adjusts a flow rate of a liquid which passes through the upstream-side piping 151. The valve 162 is disposed in the downstream-side piping 161. The valve 162 adjusts an opening degree of a flow channel inside the downstream-side piping 161 and adjusts a flow rate of a liquid which passes through the downstream-side piping 161. Specifically, each of the valve 152 and the valve 162 includes a valve body (not shown) with a valve seat provided therein, a valve element which opens/closes the valve seat, and an actuator (not shown) which moves the valve element between an open position and a closed position. It is noted that the valve 152 is an example of a “third valve” of the present invention. Also, the valve 162 is an example of a “fourth valve” of the present invention.

The substrate processing apparatus 100 is provided with a removing liquid supplying portion 165. The removing liquid supplying portion 165 is connected to one of the upstream-side piping 151 and the downstream-side piping 161. The removing liquid supplying portion 165 supplies a bubble removing liquid which removes bubbles clogging the filter 141 to the one of the upstream-side piping 151 and the downstream-side piping 161. The removing liquid supplying portion 165 includes, for example, a tank for storing the bubble removing liquid and/or a pump for feeding the bubble removing liquid. In the first preferred embodiment, the removing liquid supplying portion 165 is connected to the upstream-side piping 151 and supplies the bubble removing liquid to the upstream-side piping 151. Although the bubble removing liquid is not in particular restricted as long as it is a liquid which removes bubbles, it includes, for example, IPA (isopropyl alcohol) or PGMEA (propylene glycol monomethyl ether acetate). In the first preferred embodiment, the bubble removing liquid includes IPA. In the first preferred embodiment, the bubble removing liquid is, for example, diluted IPA.

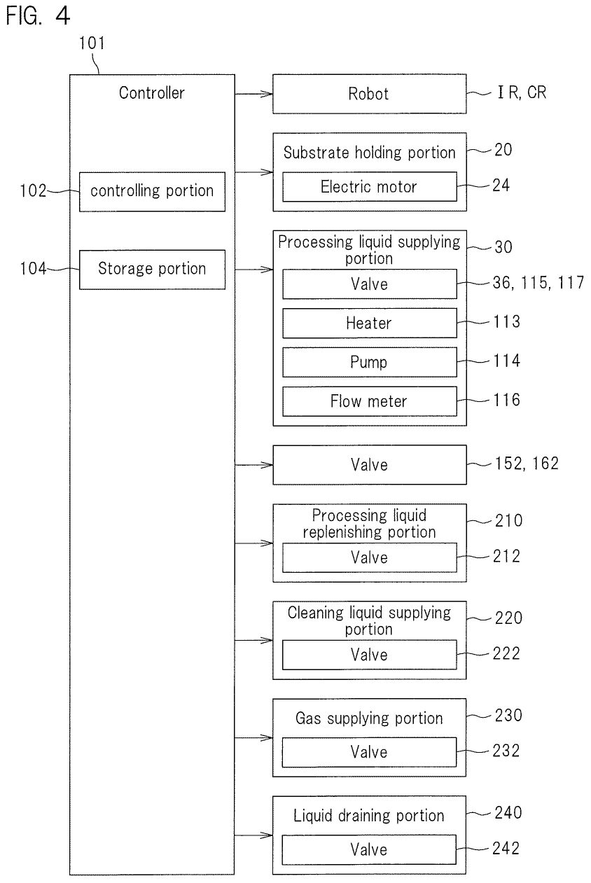

Next, with reference to FIG. 1 to FIG. 4, a description will be given of the substrate processing apparatus 100 of the first preferred embodiment. FIG. 4 is a block diagram of the substrate processing apparatus 100 of the first preferred embodiment.

As shown in FIG. 4, the controller 101 controls various types of operations of the substrate processing apparatus 100. The controller 101 controls the indexer robot IR, the center robot CR, the substrate holding portion 20, the processing liquid supplying portion 30, the valves 152, 162, the processing liquid replenishing portion 210, the cleaning liquid supplying portion 220, the gas supplying portion 230, and the liquid draining portion 240. Specifically, the controller 101 sends a control signal to the indexer robot IR, the center robot CR, the substrate holding portion 20, the processing liquid supplying portion 30, the valves 152, 162, the processing liquid replenishing portion 210, the cleaning liquid supplying portion 220, the gas supplying portion 230, and the liquid draining portion 240 and controls the indexer robot IR, the center robot CR, the substrate holding portion 20, the processing liquid supplying portion 30, the valves 152, 162, the processing liquid replenishing portion 210, the cleaning liquid supplying portion 220, the gas supplying portion 230, and the liquid draining portion 240.

More specifically, the controlling portion 102 controls the indexer robot IR and delivers a substrate W by the indexer robot IR.

The controlling portion 102 controls the center robot CR and delivers the substrate W by the center robot CR. For example, the center robot CR receives an unprocessed substrate W and carries the substrate W in any one of the plurality of substrate processing units 10. Also, the center robot CR also receives the processed substrate W from the substrate processing unit 10 and carries out the substrate W.

The controlling portion 102 controls start of rotation of the substrate W, change in rotational rate and stop of rotation of the substrate W by controlling the substrate holding portion 20. For example, the controlling portion 102 can control the substrate holding portion 20 and thereby change a rotational speed of the substrate holding portion 20. Specifically, the controlling portion 102 can change a rotational speed of the substrate W by changing a rotational speed of the electric motor 24 of the substrate holding portion 20.

The controlling portion 102 can control the valve 115, the valve 117, and the valve 36 and thereby switch the state of the valve 115, the valve 117, and the valve 36 to an open state or a closed state. Specifically, by bringing the valve 115 in an open state or in a closed state, the controlling portion 102 can allow or inhibit a liquid inside the upstream portion 32a of the piping 32 to pass through. Also, by bringing the valve 117 to an open state or in a closed state, the controlling portion 102 can allow or inhibit a liquid inside the downstream portion 32b of the piping 32 to pass through. Also, by bringing the valve 36 in an open state or in a closed state, the controlling portion 102 can allow or inhibit a liquid which has passed through the valve 117 to be supplied to the nozzle 34.

The controlling portion 102 controls the heater 113 and heats a liquid which passes through the piping 32. The controlling portion 102 controls the heater 113 and heats a liquid which passes through the piping 32 to a predetermined temperature. The controlling portion 102 controls the pump 114 and thereby sends out a liquid inside the preparation tank 112 to the downstream side. Specifically, the controlling portion 102 drives the pump 114 and sends out the liquid inside the preparation tank 112 toward the nozzle 34. Measurement results of the flow meter 116 are sent to the controlling portion 102.

The controlling portion 102 can control the valve 152 and thereby switch the state of the valve 152 to an open state or a closed state. Specifically, by bringing the valve 152 to an open state or a closed state, the controlling portion 102 can allow or inhibit a liquid inside the upstream-side piping 151 to pass through. Also, the controlling portion 102 can control the valve 162 and thereby switch the state of the valve 162 to an open state or a closed state. Specifically, by bringing the valve 162 to an open state or in a closed state, the controlling portion 102 can allow or inhibit a liquid inside the downstream-side piping 161 to pass through.

The controlling portion 102 controls replenishment of the processing liquid to the preparation tank 112 by controlling the processing liquid replenishing portion 210. Specifically, by bringing the valve 212 in an open state or in a closed state, the controlling portion 102 can replenish or stop replenishment of the processing liquid to the preparation tank 112.

The controlling portion 102 controls supply of the cleaning liquid to the preparation tank 112 by controlling the cleaning liquid supplying portion 220. Specifically, by bringing the valve 222 in an open state or in a closed state, the controlling portion 102 can supply or stop the supply of the cleaning liquid to the preparation tank 112.

The controlling portion 102 controls supply of a gas to the preparation tank 112 by controlling the gas supplying portion 230. Specifically, by bringing the valve 232 in an open state or in a closed state, the controlling portion 102 can supply or stop the supply of the gas to the preparation tank 112.

The controlling portion 102 controls the drain of a liquid from the preparation tank 112 by controlling the liquid draining portion 240. Specifically, by bringing the valve 242 in an open state or in a closed state, the controlling portion 102 can drain or stop the drain of the liquid from the preparation tank 112.

As described above, the storage portion 104 may store a plurality of recipe data. The plurality of recipes may regulate processing contents and processing procedures for removing bubbles which are clogging the filter unit 140.

The substrate processing apparatus 100 of the first embodiment is favorably used to form a semiconductor element. The substrate processing apparatus 100 is used favorably, for example, to process the substrate W which is used as a semiconductor element having a laminated structure. The semiconductor element is a memory (storage) having a so-called 3D structure. As an example, the substrate W is favorably used as an NAND-type flash memory.

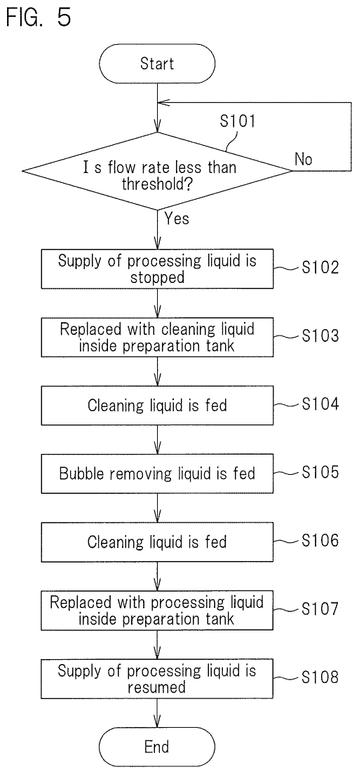

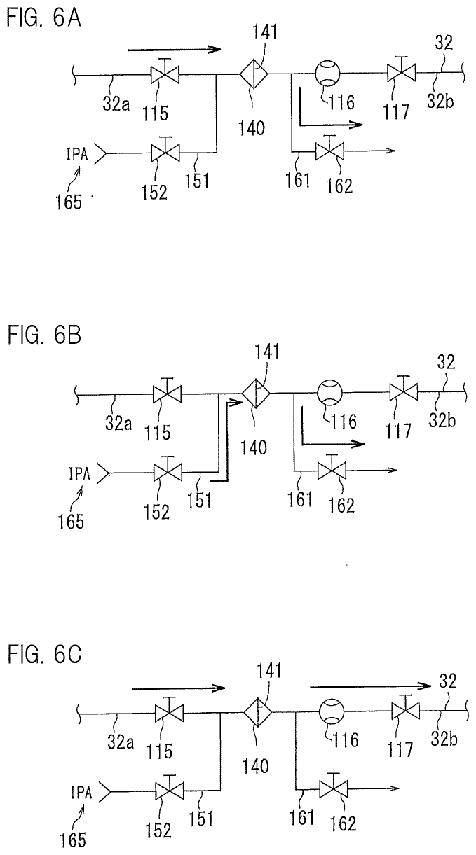

Next, with reference to FIG. 5, FIG. 6A, FIG. 6B and FIG. 6C, a description will be given of a method for removing bubbles from the filter 141 by the substrate processing apparatus 100 of the first preferred embodiment. FIG. 5 is a flow chart which shows the method for removing bubbles from the filter 141 of the first preferred embodiment. FIG. 6A to FIG. 6C are each a schematic diagram for describing the method for removing bubbles of the first preferred embodiment as well as a drawing in which a flow of a liquid around the filter unit 140 is indicated with arrows. The method for removing bubbles from the filter 141 of the first preferred embodiment includes Step S101 to Step S108. Step S101 to Step S108 are executed by the controlling portion 102. It is noted that Step S101 is an example of a “processing liquid flowing step” of the present invention. Also, Step S105 is an example of a “removing liquid flowing step” of the present invention. Also, Step S106 is an example of a “cleaning liquid flowing step” of the present invention.

As shown in FIG. 5, in Step S101, the controlling portion 102 determines whether or not a flow rate of the processing liquid which passes through the piping 32 is less than a threshold. The threshold is a predetermined value. Specifically, in Step S101, the valve 115 and the valve 117 are in an open state, while the valve 152 and the valve 162 are in a closed state. The valve 36 is switched to an open state or a closed state in synchronization with the timing at which the processing liquid is discharged to the substrate W. That is, in Step S101, the processing liquid is fed to the filter 141 which is disposed in the piping 32. Also, in Step S101, the processing liquid is allowed to flow through the piping 32 and supplied to the substrate processing unit 10. The controlling portion 102 determines whether or not a measured value of the flow meter 116 is less than a threshold in a state where the processing liquid can pass through the piping 32 (for example, the valve 36 is in an open state). It is noted that, for example, in a state where the filter 141 is new, the flow meter 116 indicates a measured value which is not less than a threshold. On the other hand, when bubbles clog the filter 141, the processing liquid which passes through the filter 141 is decreased in flow rate, and therefore the measured value of the flow meter 116 is decreased. Then, when the amount of the bubbles which are clogging the filter 141 exceeds a predetermined amount, the measured value of the flow meter 116 becomes less than a threshold.

In Step S101, in a case where the controlling portion 102 determines that a flow rate of the processing which passes through the liquid piping 32 is not less than a threshold, the processing of Step S101 is repeated. In other words, in a state where a measured value of the flow meter 116 is not less than a threshold, the processing of Step S101 is repeated.

On the other hand, in Step S101, in a case where the controlling portion 102 determines that a flow rate of the processing liquid which passes through the piping 32 is less than a threshold, the processing proceeds to Step S102. In other words, in a state where a measured value of the flow meter 116 is less than a threshold, the processing proceeds to Step S102.

Next, in Step S102, the controlling portion 102 stops supply of the processing liquid. Specifically, the controlling portion 102 switches the valve 115 and the valve 117 from an open state to a closed state.

Next, in Step S103, the controlling portion 102 replaces the processing liquid with the cleaning liquid inside the preparation tank 112. Specifically, the controlling portion 102 switches the valve 242 from a closed state to an open state. Thereby, the processing liquid inside the preparation tank 112 is drained via the piping 241. Thereafter, the controlling portion 102 returns the valve 242 from an open state to a closed state. Then, the controlling portion 102 switches the valve 222 from a closed state to an open state. Thereby, the cleaning liquid is sent into the preparation tank 112 and replacement with the cleaning liquid is performed inside the preparation tank 112. Thereafter, the controlling portion 102 returns the valve 222 from an open state to a closed state.

Next, in Step S104, the controlling portion 102 feeds the cleaning liquid to the filter 141. Specifically, the controlling portion 102 switches the valve 115 and the valve 162 from a closed state to an open state. Thereby, as shown in FIG. 6A, the cleaning liquid inside the preparation tank 112 passes through the piping 32 and the filter unit 140, and is thereafter drained via the downstream-side piping 161. Then, the controlling portion 102 returns the valve 115 from an open state to a closed state. Thus, replacement of the processing liquid with the cleaning liquid is performed inside the filter unit 140. It is noted that, although in the present preferred embodiment, in Step S102, the valve 117 is switched from an open state to a closed state, timing at which the valve 117 is switched from an open state to a closed state may be, for example, in Step S104 or in Step S103.

Next, in Step S105, the controlling portion 102 feeds the bubble removing liquid to the filter 141. Specifically, the controlling portion 102 switches the valve 152 from a closed state to an open state. Thereby, as shown in FIG. 6B, the bubble removing liquid of the removing liquid supplying portion 165 passes through the upstream-side piping 151 and the filter unit 140, and is thereafter drained via the downstream-side piping 161. At this time, the bubble removing liquid passes through the filter 141, and bubbles which have clogged the filter 141 are thereby removed. That is, the passing performance of the filter 141 is restored. Then, the controlling portion 102 returns the valve 152 from an open state to a closed state.

Next, in Step S106, the controlling portion 102 feeds the cleaning liquid to the filter 141. Specifically, the controlling portion 102 switches the valve 115 from a closed state to an open state. Thereby, as shown in FIG. 6A, the cleaning liquid inside the preparation tank 112 passes through the piping 32 and the filter unit 140, and is thereafter drained via the downstream-side piping 161. Then, the controlling portion 102 returns the valve 115 from an open state to a closed state. Thus, replacement of the bubble removing liquid with the cleaning liquid is performed inside the filter unit 140.

Next, in Step S107, the controlling portion 102 replaces the cleaning liquid with the processing liquid inside the preparation tank 112. Specifically, the controlling portion 102 switches the valve 242 from a closed state to an open state. Thereby, the cleaning liquid inside the preparation tank 112 is drained via the piping 241. Thereafter, the controlling portion 102 returns the valve 242 from an open state to a closed state. Then, the controlling portion 102 switches the valve 212 from a closed state to an open state. Thereby, the processing liquid is sent into the preparation tank 112 and replacement with the processing liquid is performed inside the preparation tank 112. Thereafter, the controlling portion 102 returns a state of the valve 212 from an open state to a closed state.

Next, in Step S108, the controlling portion 102 resumes supply of the processing liquid. Specifically, the controlling portion 102 switches the valve 115 and the valve 117 from a closed state to an open state and also switches the valve 162 from an open state to a closed state. Thereby, as shown in FIG. 6C, the processing liquid inside the preparation tank 112 passes through the filter unit 140 and the valve 117.

In detail, the controlling portion 102 switches the valve 115 from a closed state to an open state. Thereby, the cleaning liquid inside the piping 32 and the filter unit 140 is drained via the downstream-side piping 161. The controlling portion 102 switches the valve 162 from an open state to a closed state after the elapse of a predetermined period of time from when switching the valve 115 from a closed state to an open state and also switches the valve 117 from a closed state to an open state. Therefore, the cleaning liquid inside the piping 32 and the filter unit 140 can be prevented from passing through the valve 117. It is noted that at a timing at which the valve 115 is switched from a closed state to an open state, the valve 117 may be switched from a closed state to an open state and also the valve 162 may be switched from an open state to a closed state.

As thus described, removal of bubbles from the filter 141 of the first preferred embodiment ends.

With reference to FIG. 1 to FIG. 5 and FIG. 6A to FIG. 6C, a description has been so far given of the first preferred embodiment of the present invention. In the first preferred embodiment, as described above, the bubble removing liquid is allowed to pass from the upstream-side piping 151 via the filter 141 to the downstream-side piping 161. Therefore, it is possible to remove bubbles which have clogged the filter 141. That is, it is possible to restore the passing performance of the filter 141. Thus, it is possible to reduce the frequency of replacing the filter 141. As a result, the environmental load can be reduced.

Also, by reducing the frequency of replacing the filter 141, the time required for replacing and restoring the filter 141 (also referred to as downtime) can be shortened.

Also, as described above, the cleaning liquid is allowed to pass from a cleaning piping 171 via the filter 141 to the downstream-side piping 161. It is therefore possible to prevent the processing liquid from being mixed or in contact with the bubble removing liquid. In a case where the processing liquid and the bubble removing liquid react with each other, they are elevated, for example, in temperature and pressure, which may adversely influence the piping 32, the pump 114, the valve 115, the filter unit 140, the flow meter 116, or the valve 117, etc. Thus, in the first preferred embodiment, by allowing the cleaning liquid to pass through and thereby prevent the processing liquid from being mixed or in contact with the bubble removing liquid, the processing liquid and the bubble removing liquid can be prevented from being elevated in temperature and pressure. As a result, it is possible to prevent the piping 32, the pump 114, the valve 115, the filter unit 140, the flow meter 116, or the valve 117, etc., from being adversely influenced.

Also, as described above, in a case where a flow rate of the processing liquid which passes through filter 141 is measured and the flow rate of the processing liquid is less than a threshold, the bubble removing liquid is allowed to pass from the upstream-side piping 151 via the filter 141 to the downstream-side piping 161. Therefore, the flow meter 116 can be used to easily confirm clogging of bubbles, a direct observation of which would be otherwise difficult. Also, bubbles are removed in a case where the flow rate of the processing liquid becomes less than a certain threshold, and it is therefore possible to remove bubbles before a large amount of bubbles cause clogging. Thus, it is possible to reduce the time required for feeding the processing liquid and the cleaning liquid to the filter 141 from being prolonged.

### Second Preferred Embodiment

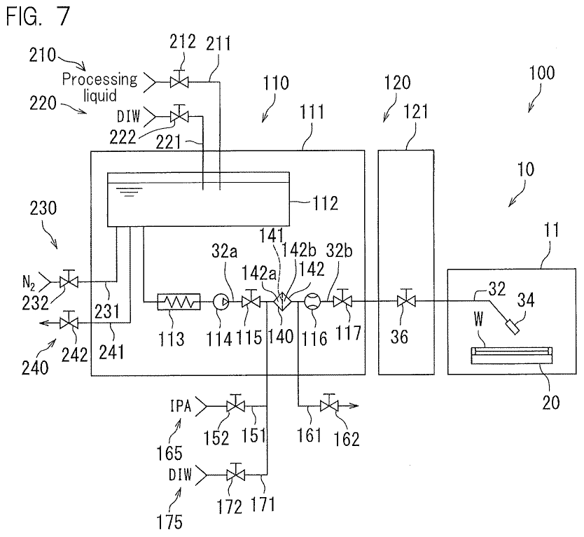

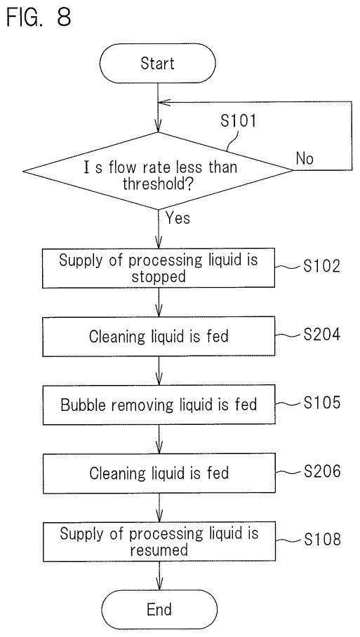

Next, with reference to FIG. 7 and FIG. 8, description will be given of the substrate processing apparatus 100 according to a second preferred embodiment of the present invention. FIG. 7 is a schematic diagram for describing a piping configuration in the substrate processing apparatus 100 of the second preferred embodiment. In the second preferred embodiment, a description will be given of an example in which the cleaning piping 171 which is connected to the piping 32 and a cleaning liquid supplying portion 175 which is connected to the cleaning piping 171 are provided.

As shown in FIG. 7, the substrate processing apparatus 100 is provided with the cleaning piping 171, a valve 172, and the cleaning liquid supplying portion 175. It is noted that the valve 172 is an example of a “fifth valve” of the present invention.

The cleaning piping 171 is connected to the piping 32 at the upstream side or the downstream side of the filter 141. In the second preferred embodiment, the cleaning piping 171 is connected to the piping 32 at the upstream side 4 the filter 141. Also, in the second preferred embodiment, the cleaning piping 171 is directly connected to the piping 32. In other words, the cleaning piping 171 is connected to the piping 32 without passing through the filter unit 140. It is noted that as shown in FIG. 7, the cleaning piping 171 may be connected to the piping 32 after joining with an upstream-side piping 151. In other words, a part of the cleaning piping 171 and a part of the upstream-side piping 151 are made into a common piping, which is then connected to the piping 32. Also, although not shown, the cleaning piping 171 may be connected to the piping 32 without joining with the upstream-side piping 151.

The valve 172 is disposed in the cleaning piping 171. The valve 172 adjusts an opening degree of a flow channel inside the cleaning piping 171 and adjusts a flow rate of a liquid which passes through the cleaning piping 171. Specifically, the valve 172 includes a valve body (not shown) with a valve seat provided therein, a valve element which opens/closes the valve seat, and an actuator (not shown) which moves the valve element between an open position and a closed position.

The cleaning liquid supplying portion 175 is connected to the cleaning piping 171. The cleaning liquid supplying portion 175 supplies a cleaning liquid to the cleaning piping 171. The cleaning liquid supplying portion 175 includes, for example, a tank for storing the cleaning liquid and/or a pump for feeding the cleaning liquid. The cleaning liquid may contain any one of, for example, deionized water (DIW), carbonated water, electrolyzed ion water, Ozone water, ammonia water, hydrochloric acid solution with a diluted concentration (for example, about 10 ppm to 100 ppm) and reduced water (hydrogen water). In the second preferred embodiment, the cleaning liquid which is supplied by the cleaning liquid supplying portion 175 is deionized ion water (DIW).

The controlling portion 102 is able to switch the state of the valve 172 to an open state or a closed state by controlling the valve 172. Specifically, by bringing the valve 172 to an open state or a closed state, the controlling portion 102 can allow or inhibit a liquid inside the cleaning piping 171 to pass through. It is noted that in the second preferred embodiment, the cleaning liquid supplying portion 220 is not necessarily provided.

The other configurations of the second preferred embodiment are the same as those of the first preferred embodiment.

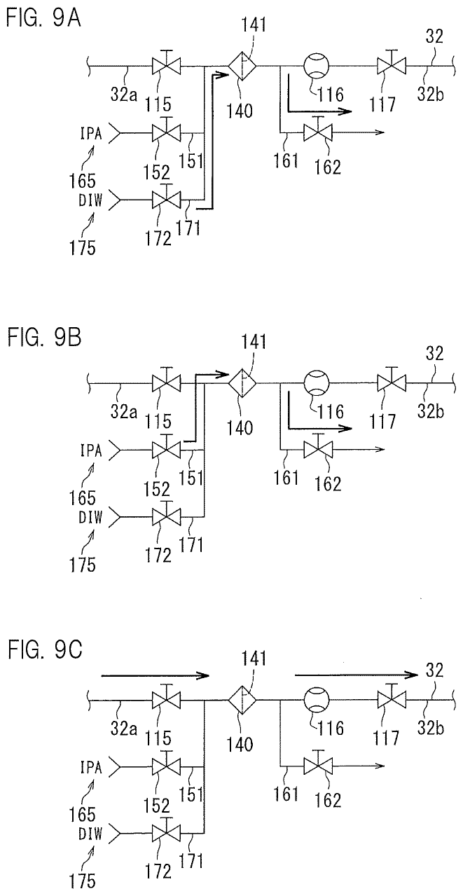

Next, with reference to FIG. 8, FIG. 9A, FIG. 9B, and FIG. 9C, a description will be given of a method for removing bubbles from the filter 141 by the substrate processing apparatus 100 of the second preferred embodiment. FIG. 8 is a flow chart which shows a method for removing bubbles from the filter 141 of the second preferred embodiment. FIG. 9A to FIG. 9C are each a schematic diagram for describing the method for removing bubbles of the second preferred embodiment as well as a drawing in which a flow of a liquid around the filter unit 140 is indicated with arrows. The method for removing bubbles from the filter 141 of the second preferred embodiment includes Step S101, S102, S204, S105, S206, and S108. It is noted that unlike the first preferred embodiment, a step of replacing a liquid inside the preparation tank 112 is not included in the second preferred embodiment. Steps S204 and S206 of the second preferred embodiment correspond to Steps S104 and S106 of the first preferred embodiment. It is noted that Step S206 is an example of the “cleaning liquid flowing step” of the present invention.

As shown in FIG. 8, in Step S101, the controlling portion 102 determines whether or not a flow rate of the processing liquid which passes through the piping 32 is less than a threshold. It is noted that in Step S101, the valve 172 is in a closed state.

In Step S101, in a case where the controlling portion 102 determines that a flow rate of the processing which passes through the liquid piping 32 is not less than a threshold, the processing of Step S101 is repeated.

On the other hand, in Step S101, in a case where the controlling portion 102 determines that a flow rate of the processing liquid which passes through the piping 32 is less than a threshold, the processing proceeds to Step S102.

Next, in Step S102, the controlling portion 102 stops supply of the processing liquid. Specifically, the controlling portion 102 switches the valve 115 and the valve 117 from an open state to a closed state.

Next, in Step S204, the controlling portion 102 feeds the cleaning liquid to the filter 141. Specifically, the controlling portion 102 switches the valve 172 and the valve 162 from a closed state to an open state. Thereby, as shown in FIG. 9A, the cleaning liquid of the cleaning liquid supplying portion 175 passes through the cleaning piping 171 and the filter unit 140, and is thereafter drained via the downstream-side piping 161. Then, the controlling portion 102 returns the valve 172 from an open state to a closed state. Thus, replacement of the processing liquid with the cleaning liquid is performed inside the filter unit 140.

Next, in Step S105, the controlling portion 102 feeds a bubble removing liquid to the filter 141. Specifically, the controlling portion 102 switches the valve 152 from a closed state to an open state. Thereby, as shown in FIG. 9B, the removing liquid of the removing liquid supplying portion 165 passes through the upstream-side piping 151 and the filter unit 140, and is thereafter drained via the downstream-side piping 161. At this time, the removing liquid passes through the filter 141, by which bubbles which are clogging the filter 141 are removed. That is, the passing performance of the filter 141 is restored. Then, the controlling portion 102 returns the valve 152 from an open state to a closed state.

Next, in Step S206, the controlling portion 102 feeds a cleaning liquid to the filter 141. Specifically, the controlling portion 102 switches the valve 172 from a closed state to an open state. Thereby, as shown in FIG. 9A, the cleaning liquid of the cleaning liquid supplying portion 175 passes through the cleaning piping 171 and the filter unit 140, and is thereafter drained via the downstream-side piping 161. Then, the controlling portion 102 returns the valve 172 from an open state to a closed state. Thus, replacement of the bubble removing liquid with the cleaning liquid is performed inside the filter unit 140.

Next, in Step S108, the controlling portion 102 resumes supply of the processing liquid. Thereby, as shown in FIG. 9C, the processing liquid inside the preparation tank 112 passes through the filter unit 140 and the valve 117.

As thus described, removal of bubbles from the filter 141 of the second preferred embodiment ends.

In the second preferred embodiment, as described above, the cleaning piping 171 which is connected to the piping 32 is provided, and the cleaning liquid is allowed to pass from the cleaning piping 171 via the filter 141 to the downstream-side piping 161. Therefore, it is not necessary to provide a step of performing replacement with the cleaning liquid inside the preparation tank 112 (Step S103) or a step of performing replacement with the processing liquid inside the preparation tank 112 (Step S107). Thus, it is possible to simplify a step of restoring the filter 141. Also, it is not necessary to perform replacement with the cleaning liquid inside the preparation tank 112 or to perform replacement with the processing liquid inside the preparation tank 112, it is therefore possible to reduce a consumption amount of the processing liquid and the cleaning liquid. It is therefore possible to further reduce the environmental load.

The other methods for removing bubbles and other effects of the second preferred embodiment are the same as those of the first preferred embodiment.

### First Modified Example

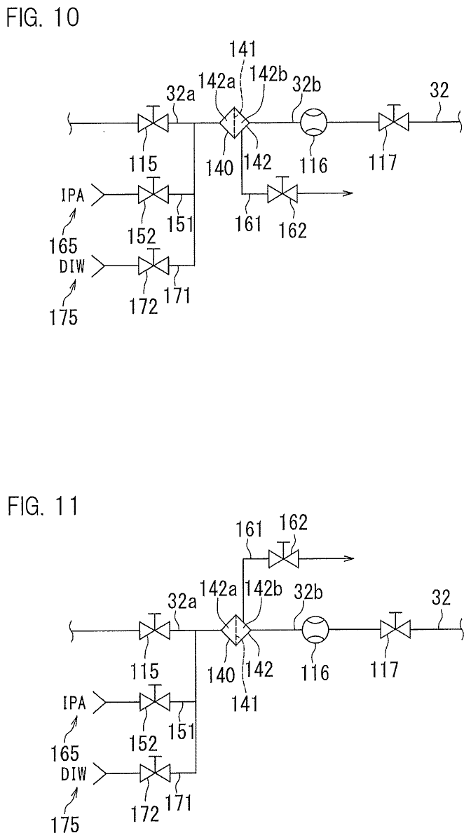

Next, with reference to FIG. 10, a description will be given of the substrate processing apparatus 100 according to a first modified example of the present invention. FIG. 10 is a schematic diagram for describing a piping configuration in the substrate processing apparatus 100 of the first modified example. In the first modified example, unlike the first preferred embodiment and the second preferred embodiment, a description will be given of an example in which the downstream-side piping 161 is connected to the filter unit 140. It is noted that, although a description will be given here by partially modifying the piping configuration of the second preferred embodiment shown in FIG. 7, the piping configuration of the first preferred embodiment shown in FIG. 3 may be partially modified.

As shown in FIG. 10, in the substrate processing apparatus 100 of the first modified example, the downstream-side piping 161 is connected to the downstream portion 32b of the piping 32 at the downstream side of the filter 141. Specifically, the downstream-side piping 161 is connected to the piping 32 via the filter unit 140. The downstream-side piping 161 is connected to the piping 32 via the downstream chamber 142b of the filter unit 140.

In the first modified example, as with the first preferred embodiment and the second preferred embodiment, a liquid which has passed through the filter 141 can be drained via the downstream-side piping 161.

The downstream-side piping 161 is connected, for example, to a lower portion of the downstream chamber 142b. In a configuration that, for example, a drain pipe for releasing outside a liquid which has passed through the filter 141 is connected to the downstream chamber 142b of the filter unit 140, the drain pipe may be used as the downstream-side piping 161. In other words, the drain pipe which is provided in advance may be used also as the downstream-side piping 161. According to the above-described configuration, since it is not necessary to separately provide the downstream-side piping 161, it is possible to reduce the increase in the number of components of substrate processing apparatus 100.

The other configurations, the method for removing bubbles and other effects of the first modified example are the same as those of the first preferred embodiment and the second preferred embodiment.

### Second Modified Example

Next, with reference to FIG. 11, a description will be given of the substrate processing apparatus 100 according to a second modified example of the present invention. FIG. 11 is a schematic diagram for describing a piping configuration of the substrate processing apparatus 100 of the second modified example. In the second modified example, unlike the first modified example, a description will be given of an example in which the downstream-side piping 161 is connected to an upper portion of the downstream chamber 142b of the filter unit 140. It is noted that, although a description will be given here by partially modifying the piping configuration of the second preferred embodiment shown in FIG. 7, the piping configuration of the first preferred embodiment shown in FIG. 3 may be partially modified.

As shown in FIG. 11, in the substrate processing apparatus 100 of the second modified example, as with the first modified example, the downstream-side piping 161 is connected to the piping 32 via the downstream chamber 142b of the filter unit 140. In the second modified example, as with the first modified example, a liquid which has passed through the filter 141 can be drained via the downstream-side piping 161.

In the second modified example, the downstream-side piping 161 is connected, for example, to an upper portion of the downstream chamber 142b. For example, in a configuration that a ventilation pipe for releasing outside a gas which has passed through the filter 141 is connected to the downstream chamber 142b of the filter unit 140, the ventilation pipe may be used as the downstream-side piping 161. In other words, the ventilation pipe which is provided in advance may be also used as the downstream-side piping 161. According to the above-described configuration, since it is not necessary to separately provide the downstream-side piping 161, it is possible to suppress an increase in the number of components of the substrate processing apparatus 100.

The other configurations, the method for removing bubbles and other effects of the second modified example are the same as those of the first modified example.

### Third Preferred Embodiment

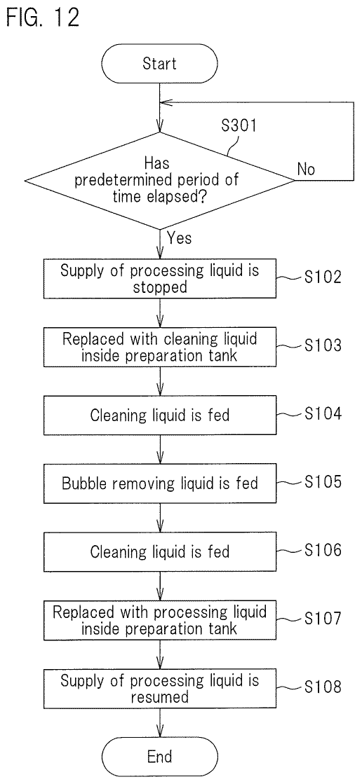

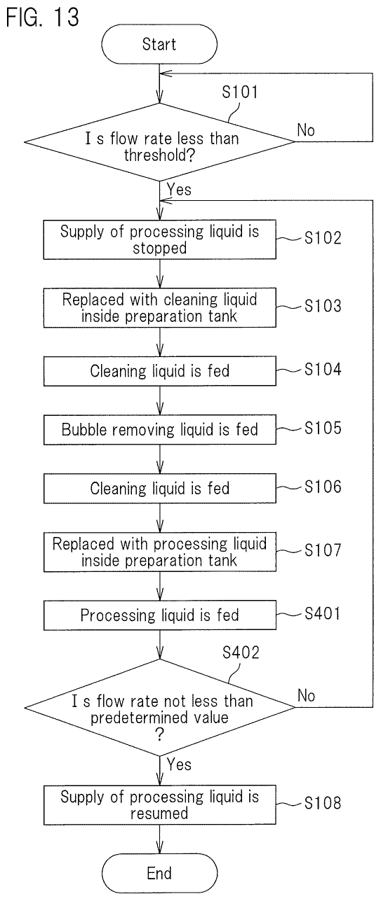

Next, with reference to FIG. 12, a description will be given of the substrate processing apparatus 100 according to a third preferred embodiment of the present invention. In the third preferred embodiment, unlike the first preferred embodiment and the second preferred embodiment, a description will be given of an example in which bubbles are removed on a regular basis. It is noted that, although a description will be given here by partially modifying the method for removing bubbles of the first preferred embodiment shown in FIG. 5, the method for removing bubbles of the second preferred embodiment shown in FIG. 8 may be partially modified.

The configuration of the substrate processing apparatus 100 of the third preferred embodiment is the same as that of the first preferred embodiment or the second preferred embodiment. However, in the third preferred embodiment, the substrate processing apparatus 100 does not have to be provided with the flow meter 116.

FIG. 12 is a flow chart which shows a method for removing bubbles from the filter 141 of the third preferred embodiment. The method for removing bubbles from the filter 141 of the third preferred embodiment includes Steps S301 and S102 to S108. It is noted that Step S301 is an example of the “processing liquid flowing step” of the present invention. In Step S301, as with the above-described Step S101, a processing liquid is fed to the filter 141. Also, in Step S301, the processing liquid is allowed to flow through the piping 32 and supplied to the substrate processing unit 10.

As shown in FIG. 12, in Step S301, the controlling portion 102 determines whether or not a predetermined period of time has elapsed. The predetermined period of time is a previously-determined period of time. The predetermined period of time is, for example, the time elapsed since the last time filter 141 was replaced or bubbles were removed, or the accumulated operation time of the substrate processing apparatus 100. Also, the predetermined period of time may be, for example, the accumulated time of feeding a processing liquid since the last time filter 141 was replaced or bubbles were removed. The accumulated time of feeding the processing liquid corresponds to a flow rate of the processing liquid. The substrate processing apparatus 100 is preferably provided with a timer or a flow meter to measure the above-mentioned predetermined period of time.

Also, the predetermined period of time since the last time the filter 141 was replaced and the predetermined period of time since the last time the bubbles were removed from the filter 141 may differ. In this case, the predetermined period of time in a case where the replacement of the filter 141 may be set longer as compared to the predetermined period of time in a case where the bubbles are removed from the filter 141.

In Step S301, in a case where the controlling portion 102 determines that the predetermined period of time has not elapsed, the processing of Step S301 is repeated.

On the other hand, in Step S301, in a case where the controlling portion 102 determines that the predetermined period of time has elapsed, the processing proceeds to Step S102.

Then, Step S102 to Step S108 are executed.

The other methods for removing bubbles of the third preferred embodiment are the same as those of the first preferred embodiment or the second preferred embodiment.

In the third preferred embodiment, as described above, the bubble removing liquid is allowed to pass from the upstream-side piping 151 via the filter 141 to the downstream-side piping 161 on a regular basis. It is therefore possible to remove bubbles before a large amount of bubbles cause clogging. Thus, it is possible to reduce the time required for feeding the processing liquid and the cleaning liquid to the filter 141 from being prolonged.

The other effects of the third preferred embodiment are the same as those of the first preferred embodiment or the second preferred embodiment.

### Fourth Preferred Embodiment

Next, with reference to FIG. 13, a description will be given of the substrate processing apparatus 100 according to a fourth preferred embodiment of the present invention. In the fourth preferred embodiment, unlike the first preferred embodiment to the third preferred embodiment, a description will be given of an example in which supply of a processing liquid is resumed after confirmation of restoration of the filter 141. It is noted that, although a description will be given here by partially modifying the method for removing bubbles of the first preferred embodiment shown in FIG. 5, the method for removing bubbles of the third preferred embodiment shown in FIG. 12 may be partially modified.

The configuration of the substrate processing apparatus 100 of the fourth preferred embodiment is the same as that of the first preferred embodiment or the third preferred embodiment.

FIG. 13 is a flow chart which shows a method for removing bubbles from the filter 141 of the fourth preferred embodiment. The method for removing bubbles from the filter 141 of the fourth preferred embodiment includes Steps S101 to S107, S401, S402 and S108. It is noted that Step S402 is an example of a “measurement step” of the present invention.

As shown in FIG. 13, Step S101 to Step S107 are the same as those of the first preferred embodiment. After Step S107, the processing proceeds to Step S401. Step S401 is executed prior to Step S108.

In Step S401, the controlling portion 102 feeds a processing liquid to the filter 141. Specifically, the controlling portion 102 switches the valve 115 and the valve 117 from a closed state to an open state. Thereby, the processing liquid inside the preparation tank 112 passes through the piping 32 and the filter unit 140, and thereafter passes through the flow meter 116.

Next, in Step S402, the controlling portion 102 determines whether or not a flow rate of the processing liquid which passes through the flow meter 116 is not less than a predetermined value. That is, the controlling portion 102 determines whether or not a flow rate of the processing liquid which passes through the filter 141 is not less than a predetermined value. In other words, the controlling portion 102 determines whether or not the filter 141 has been restored. It is noted that the “predetermined value” of Step S402 is larger than the “threshold” of Step S101. However, the “predetermined value” of Step S402 may be equal to the “threshold” of Step S101.

In Step S402, in a case where the controlling portion 102 determines that the flow rate of the processing liquid which passes through the flow meter 116 is less than a predetermined value, the processing returns to Step S102. Thereby, feeding of the processing liquid to the filter 141 is executed again.

On the other hand, in Step S402, in a case where the controlling portion 102 determines that the flow rate of the processing liquid which passes through the flow meter 116 is not less than a predetermined value, the processing proceeds to Step S108. Then, for example, supply of the processing liquid to the nozzle 34 is resumed.

As thus described, removal of bubbles from the filter 141 of the fourth preferred embodiment ends.

The other methods for removing bubbles of the fourth preferred embodiment are the same as those of the first preferred embodiment and the third preferred embodiment.

In the fourth preferred embodiment, as described above, in a case where a measured value of the flow meter 116 is less than a predetermined value after the removing liquid flowing step (Step S105), the removing liquid flowing step is executed again. It is therefore possible to resume supply of the processing liquid to the substrate processing unit 10 after the filter 141 has been reliably restored.

Also, in the fourth preferred embodiment, the feeding time of Step S104 which is executed after going through Step S402 may be made shorter than the feeding time of Step S104 (the first-time Step S104) without going through Step S402. According to the above-described configuration, it is possible to suppress an increase in the usage amount of the bubble removing liquid.

Also, in the fourth preferred embodiment, the time during which the bubble removing liquid is fed to the filter 141 in Step S105 may be changed by the controlling portion 102. Specifically, on the basis of an accumulated feeding time required in Step S105 before proceeding to Step S108, the feeding time of Step S104 (the first-time Step S104) without going through Step S402 may be automatically changed by the controlling portion 102. It is noted that the feeding time may be manually changed by a user. As thus described, on the basis of an accumulated feeding time required in Step S105 before proceeding to Step S108, by changing the feeding time of Step S104 (Step S104 for the first time) without going through Step S402, it is made possible to optimize the feeding time of Step S104 for the first time. It is therefore possible to prevent Step S102 to Step S107 from being executed multiple times. Thus, it is possible to suppress an increase in the usage amount of the cleaning liquid and/or suppress the time required for removing bubbles from being prolonged.

The other effects of the fourth preferred embodiment are the same as those of the first preferred embodiment or the third preferred embodiment.

### Fifth Preferred Embodiment

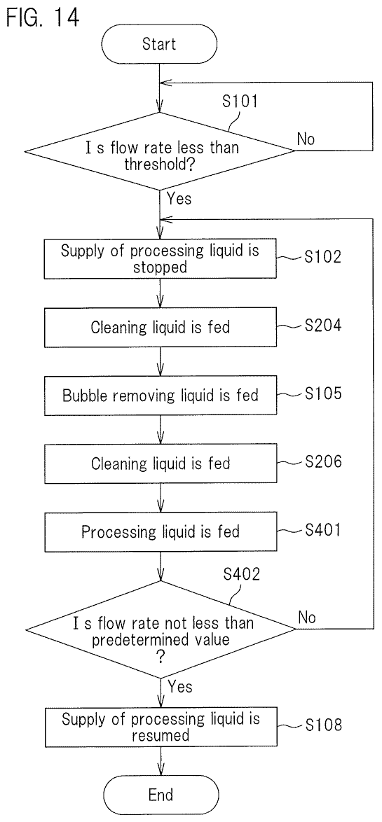

Next, with reference to FIG. 14, a description will be given of the substrate processing apparatus 100 according to a fifth preferred embodiment of the present invention. In the fifth preferred embodiment, unlike the fourth preferred embodiment, a description will be given of an example in which a step of replacing a liquid inside the preparation tank 112 is not included. It is noted that, although a description will be given here by partially modifying the method for removing bubbles of the second preferred embodiment shown in FIG. 8, the method for removing bubbles of the third preferred embodiment shown in FIG. 12 may be partially modified.

In the fifth preferred embodiment, as with the second preferred embodiment, the substrate processing apparatus 100 is provided with the cleaning piping 171 which is connected to the piping 32 at the upstream side or the downstream side of the filter 141. The cleaning piping 171 is connected to the piping 32 at the upstream side of the filter 141.

The configuration of the substrate processing apparatus 100 of the fifth preferred embodiment is the same as that of the second preferred embodiment or the third preferred embodiment.

FIG. 14 is a flow chart which shows a method for removing bubbles from the filter 141 of the fifth preferred embodiment. The method for removing bubbles from the filter 141 in the fifth preferred embodiment includes Step S101, S102, S204, S105, S206, S401, S402, and S108.

As shown in FIG. 14, Steps S101, S102, S204, S105, S206, and S108 are the same as those of the second preferred embodiment. After Step S206, the processing proceeds to Step S401. Step S401 is executed prior to Step S108.

In Step S401, the controlling portion 102 feeds a processing liquid to the filter 141. Specifically, the controlling portion 102 switches the valve 115 and the valve 117 from a closed state to an open state. Thereby, the processing liquid inside the preparation tank 112 passes through the flow meter 116 after passing through the piping 32 and the filter unit 140.

Next, in Step S402, the controlling portion 102 determines whether or not a flow rate of the processing liquid which passes through the flow meter 116 is not less than a predetermined value.

In Step S402, in a case where the controlling portion 102 determines that the flow rate of the processing liquid which passes through the flow meter 116 is less than a predetermined value, the processing returns to Step S102. Thereby, feeding of the processing liquid to the filter 141 is executed again.

On the other hand, in Step S402, in a case where the controlling portion 102 determines that the flow rate of the processing liquid which passes through the flow meter 116 is not less than a predetermined value, the processing proceeds to Step S108. Then, for example, supply of the processing liquid to a nozzle 34 is resumed.

As thus described, removal of bubbles from the filter 141 of the fifth preferred embodiment ends.

The other methods for removing bubbles of the fifth preferred embodiment are the same as those of the second preferred embodiment and the fourth preferred embodiment.

In the fifth preferred embodiment, as described above, as with the fourth preferred embodiment, in a case where a measured value of the flow meter 116 is less than a predetermined value after the removing liquid flowing step (Step S105), the removing liquid flowing step is executed again. It is therefore possible to resume supply of the processing liquid to the substrate processing unit 10 after the filter 141 has been reliably restored.

The other effects of the fifth preferred embodiment are the same as those of the second preferred embodiment or the fourth preferred embodiment.

### Sixth Preferred Embodiment

Next, with reference to FIG. 15, a description will be given of the substrate processing apparatus 100 according to a sixth preferred embodiment of the present invention. FIG. 15 is a schematic diagram for describing a piping configuration in the substrate processing apparatus 100 of the sixth preferred embodiment. In the sixth preferred embodiment, a description will be given of an example in which a processing liquid which has passed through the valve 117 is partially returned to the preparation tank 112. That is, in the sixth preferred embodiment, a description will be given of an example in which the piping 32 is configured such that the processing liquid is circulated. It is noted that, although a description will be given here by partially modifying the piping configuration of the first preferred embodiment shown in FIG. 3, the piping configuration of the second preferred embodiment shown in FIG. 7 may be partially modified.

As shown in FIG. 15, in the sixth preferred embodiment, the piping 32 includes a common piping 32c, a branch piping 32d, a return piping 32e, a common piping 32f, and a branch piping 32g. the common piping 32c is connected to the downstream portion 32b of the piping 32. A plurality (here, four) of the branch pipings 32d are connected to the common piping 32c. The branch pipings 32d are branched from the common piping 32c. The branch piping 32d supplies a processing liquid which has passed through the valve 117 to a processing liquid box 120.

The return piping 32e is connected to the common piping 32c. The return piping 32e extends to the preparation tank 112. The return piping 32e returns the processing liquid which has passed through the common piping 32c to the preparation tank 112.

The common piping 32f is, for example, disposed inside the processing liquid box 120. The common piping 32f is connected to the branch piping 32d. Also, a plurality (here, three) of the branch pipings 32g are connected to the common piping 32f. The branch pipings 32g are branched from the common piping 32f. The branch piping 32g supplies a processing liquid which has passed through the common piping 32f to the nozzle 34.

The other configurations, the method for removing bubbles and the effects of the sixth preferred embodiment are the same as those of the first preferred embodiment to the fifth preferred embodiment.

### Seventh Preferred Embodiment

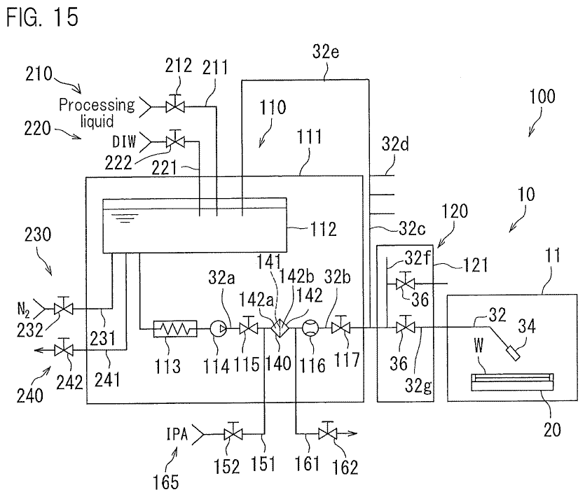

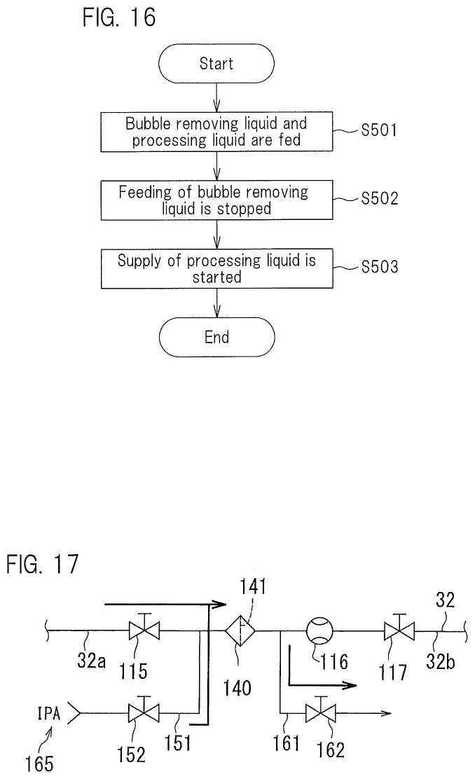

Next, with reference to FIG. 6A, FIG. 6C, FIG. 16, and FIG. 17, a description will be given of the substrate processing apparatus 100 according to a seventh preferred embodiment of the present invention. In the seventh preferred embodiment, unlike the first preferred embodiment to the sixth preferred embodiment, a description will be given of an example in which a bubble removing liquid is fed at the start of supplying a processing liquid.

In the seventh preferred embodiment, as with the sixth preferred embodiment, the piping 32 is configured such as to circulate a processing liquid. It is noted that the piping 32 does not have to be configured such as to circulate the processing liquid. Also, in the seventh preferred embodiment, the substrate processing apparatus 100 does not have to be provided with the gas supplying portion 230.

In the seventh preferred embodiment, as will be described later, the processing liquid is mixed or in contact with the bubble removing liquid. Thus, the processing liquid and the bubble removing liquid are liquids which do not react with each other or which are less likely to react with each other. At least one of the processing liquid and the bubble removing liquid in the seventh preferred embodiment is a liquid different from the first preferred embodiment.

The other configurations of the seventh preferred embodiment are the same as those of the sixth preferred embodiment.

FIG. 16 is a flow chart which shows a method for removing bubbles from the filter 141 of the seventh preferred embodiment. FIG. 17 is a schematic diagram for describing the method for removing bubbles of the seventh preferred embodiment as well as a drawing in which a flow of a liquid around a filter unit is indicated with arrows. The method for removing bubbles from the filter 141 of the seventh preferred embodiment includes Step S501 to Step S503. Step S501 to Step S503 are executed by the controlling portion 102. It is noted that Step S501 is an example of the “processing liquid flowing step” and the “removing liquid flowing step”of the present invention.

As shown in FIG. 16, in Step S501, the controlling portion 102 feeds the processing liquid and the bubble removing liquid to the filter 141. Specifically, Step S501 is executed before the start of supplying the processing liquid. For example, there is a case where bubbles are mixed into a filter unit 140 when supply of the processing liquid is started from a state where a pump 114 is stopped. A gas which has been mixed into the filter unit 140 becomes a cause of clogging of the filter 141. A state where the pump 114 is stopped includes, for example, an idle state where the circulation of the processing liquid is stopped or a state after the processing liquid inside the preparation tank 112 has been replaced, etc. It is noted that before Step S501, valves 115, 117, 152, and 162 are in a closed state.

In Step S501, the controlling portion 102 switches the valves 115, 152 and 162 from a closed state to an open state. Thereby, as shown in FIG. 17, after passing through the filter unit 140, the processing liquid and the bubble removing liquid are drained via a downstream-side piping 161. At this time, since the bubble removing liquid passes through the filter 141, even when the bubbles are mixed into the filter unit 140, the bubbles can be prevented from clogging the filter 141. It is noted that the timing at which the valve 115 is switched from a closed state to an open state and the timing at which the valve 152 is switched from a closed state to an open state may match or either one of them may be earlier than the other. Then, after the elapse of, for example, several seconds after the start of feeding the processing liquid and the bubble removing liquid, the processing proceeds to Step S502.

Next, in Step S502, the controlling portion 102 stops feeding of the bubble removing liquid. Specifically, the controlling portion 102 switches the valve 152 from an open state to a closed state. Thereby, as shown in FIG. 6A, after passing through the filter unit 140, the processing liquid is drained via the downstream-side piping 161.

Next, in Step S503, the controlling portion 102 starts supply of the processing liquid. Specifically, the valve 162 is switched from an open state to a closed state and the valve 117 is also switched from a closed state to an open state. Thereby, as shown in FIG. 6C, after passing through the filter unit 140, the processing liquid flows toward the valve 117.

As thus described, removal of bubbles from the filter 141 of the seventh preferred embodiment ends.

In the seventh preferred embodiment, as described above, when supply of the processing liquid is started from a state where the pump 114 is stopped, the processing liquid and the bubble removing liquid are fed to the filter 141. Therefore, even when the bubbles are mixed into the filter unit 140, the bubbles can be prevented from clogging the filter 141.

Other effects of the seventh preferred embodiment are the same as those of the first preferred embodiment to the sixth preferred embodiment.

The preferred embodiments of the present invention have been described above with reference to the drawings. However, the present invention is not limited to the preferred embodiments described above and can be implemented in various modes within a scope not deviating from its gist. Also, it is possible to form various inventions by appropriately combining a plurality of constituent elements disclosed in the preferred embodiments described above. For example, some constituent elements may be deleted from the total of constituent elements indicated in the preferred embodiments. Also, constituent elements across the different preferred embodiments may be combined as appropriate. The drawings mainly illustrate the respective constituent elements schematically for ease of understanding and there are cases where thicknesses, lengths, numbers, intervals, etc., of the respective constituent elements illustrated differ from actuality due to convenience of drawing preparation. Also, the material, shape, dimensions, etc., of the respective constituent elements indicated in the preferred embodiments described above are but an example, are not restricted in particular, and can be changed variously within a scope of practically not deviating from the effects of the present invention.

For example, although a description has been given, in the first preferred embodiment to the sixth preferred embodiment, of an example in which the cleaning liquid is fed before feeding of the bubble removing liquid and the cleaning liquid is fed after feeding of the bubble removing liquid, the present invention is not limited thereto. For example, after stop of supplying the processing liquid, the bubble removing liquid may be fed without feeding the cleaning liquid. Also, after feeding of the bubble removing liquid, the processing liquid may be fed without feeding the cleaning liquid. However, in a case where there is a concern that the processing liquid and the bubble removing liquid may react with each other and thereby adversely influence the components such as the piping, the valves, the filter unit, etc., it is preferable that the cleaning liquid is fed as described in the first preferred embodiment to the sixth preferred embodiment.

Also, for example, although a description has been given, in the first preferred embodiment to the sixth preferred embodiment, of an example in which the removing liquid supplying portion 165 is connected to the upstream-side piping 151 and the bubble removing liquid is allowed to pass from the upstream-side piping 151 via the filter 141 to the downstream-side piping 161, the present invention is not limited thereto. For example, the removing liquid supplying portion 165 may be connected to the downstream-side piping 161, and the bubble removing liquid may be allowed to pass from the downstream-side piping 161 via the filter 141 to the upstream-side piping 151.

Also, for example, although a description has been given, in the second preferred embodiment and the fifth preferred embodiment, of an example in which the cleaning piping 171 is connected to the piping 32 at the upstream side of the filter 141, and the cleaning liquid is allowed to pass from the cleaning piping 171 via the filter 141 to the downstream-side piping 161, the present invention is not limited thereto. For example, the cleaning piping 171 may be connected to the piping 32 at the downstream side of the filter 141, and the cleaning liquid may be allowed to pass from the cleaning piping 171 via the filter 141 to the upstream-side piping 151.

Also, for example, although a description has been given, in the fourth preferred embodiment and the fifth preferred embodiment, of an example in which the flow rate of the processing liquid is used in order to confirm restoration of the filter 141 in the measurement step (Step S402), the present invention is not limited thereto. For example, the flow rate of the cleaning liquid may be used in order to confirm restoration of the filter 141. In this case, the flow meter for measuring the flow rate of the cleaning liquid passing through the filter 141 may be disposed, for example, in the downstream-side piping 161, the piping 32, or the cleaning piping 171. Also, for example, the flow rate of the bubble removing liquid may be used in order to confirm restoration of the filter 141. In this case, the flow meter for measuring the flow rate of the bubble removing liquid passing through the filter 141 may be disposed, for example, in the downstream-side piping 161, the piping 32, or the upstream-side piping 151.

Also, although a description has been given, in the above-described preferred embodiments, of an example in which the substrate processing apparatus 100 is provided with the gas supplying portion 230, the present invention is not limited thereto and a gas does not have to be supplied to the preparation tank 112. For example, there is a case where bubbles are mixed into the filter unit 140 when replacing the filter 141. The mixed gas becomes a cause of clogging of the filter 141, however, according to the present invention, the filter 141 can be restored.

Also, although a description has been given, in the above-described preferred embodiments, of an example in which the valves 36, 115, 117, 152, 162, 172, 212, 222, 232, and 242 are valves which are capable of regulating a flow rate of a liquid, the present invention is not limited thereto. For example, the valves 36, 115, 117, 152, 162, 172, 212, 222, 232, and 242 may be valves which are not capable of adjusting a flow rate of a liquid. That is, the valves 36, 115, 117, 152, 162, 172, 212, 222, 232, and 242 may only be capable of switching the flow channel to an open state or a closed state.

### Industrial Applicability

The present invention is favorably used in the substrate processing apparatus and the method for removing bubbles from a filter.

### Reference Signs List

10 substrate processing unit
32: piping (processing liquid piping)
100: substrate processing apparatus
115: valve (first valve)
116: flow meter
117: valve (second valve)
141: filter
151: upstream-side piping
152: valve (third valve)
161: downstream-side piping
162: valve (fourth valve)
165: removing liquid supplying portion
171: cleaning piping
172: valve (fifth valve)
175: cleaning liquid supplying portion
220: cleaning liquid supplying portion
S101, S301: Step (processing liquid flowing step)
S105: Step (removing liquid flowing step)
S106, S206: Step (cleaning liquid flowing step)
S402: Step (measurement step)
S501: Step (processing liquid flowing step, removing liquid flowing step)
W: substrate

1. A substrate processing apparatus comprising:
a substrate processor to process a substrate;
a processing liquid piping through which a processing liquid flows toward the substrate processor;
a filter which is disposed in the processing liquid piping;
an upstream-side piping which is connected to the processing liquid piping at an upstream side of the filter;
a downstream-side piping which is connected to the processing liquid piping at a downstream side of the filter; and
a removing liquid supply, which is connected to one of the upstream-side piping and the downstream-side piping, to supply a bubble removing liquid to remove bubbles which are clogging the filter to the one of the upstream-side piping and the downstream-side piping; wherein
the bubble removing liquid is allowed to pass from the one of the upstream-side piping and the downstream-side piping via the filter to the other of the upstream-side piping and the downstream-side piping.

2. The substrate processing apparatus according to claim 1 further comprising:
a cleaning piping which is connected to the processing liquid piping at the upstream side or the downstream side of the filter; and
a cleaning liquid supply, which is connected to the cleaning piping, to supply a cleaning liquid so as to wash away the processing liquid to the cleaning piping; wherein
the cleaning liquid is allowed to pass from the cleaning piping via the filter to the other of the upstream-side piping and the downstream-side piping.

3. The substrate processing apparatus according to claim 2 further comprising:
a first valve which is disposed in the processing liquid piping at the upstream side of the filter;
a second valve which is disposed in the processing liquid piping at the downstream side of the filter;
a third valve which is disposed in the upstream-side piping;
a fourth valve which is disposed in the downstream-side piping; and
a fifth valve which is disposed in the cleaning piping; wherein
the processing liquid is allowed to pass from the upstream side of the processing liquid piping via the filter to the downstream side of the processing liquid piping by closing the third valve, the fourth valve, and the fifth valve and opening the first valve and the second valve,
the bubble removing liquid is allowed to pass from the one of the upstream-side piping and the downstream-side piping via the filter to the other of the upstream-side piping and the downstream-side piping by closing the first valve, the second valve, and the fifth valve and opening the third valve and the fourth valve, and
the cleaning liquid is allowed to pass from the cleaning piping via the filter to the other of the upstream-side piping and the downstream-side piping by closing the first valve and the second valve as well as the one of the third valve and the fourth valve and opening the other of the third valve and the fourth valve as well as the fifth valve.

4. The substrate processing apparatus according to claim 1 further comprising:
a flow meter, which is disposed in the processing liquid piping, to measure a flow rate of the processing liquid which passes through the filter; wherein
in a case where a measured value of the flow meter is less than a threshold, the bubble removing liquid is allowed to pass from the one of the upstream-side piping and the downstream-side piping via the filter to the other of the upstream-side piping and the downstream-side piping.

5. The substrate processing apparatus according to claim 1, wherein the bubble removing liquid is allowed to pass from the one of the upstream-side piping and the downstream-side piping via the filter to the other of the upstream-side piping and the downstream-side piping on a regular basis.

6. The substrate processing apparatus according to claim 1, further comprising: a flow meter to measures a flow rate of a liquid which passes through the filter; wherein
after the bubble removing liquid is allowed to pass from the one of the upstream-side piping and the downstream-side piping via the filter to the other of the upstream-side piping and the downstream-side piping,
in a case where a measured value of the flow meter is less than a predetermined value, the bubble removing liquid is again allowed to pass from the one of the upstream-side piping and the downstream-side piping via the filter to the other of the upstream-side piping and the downstream-side piping.

7. A method of removing bubbles from a filter comprising:
a processing liquid flowing to feed a processing liquid for processing a substrate to a filter that is disposed in a processing liquid piping which leads to a substrate processor unit; and
a removing liquid flowing to allow a bubble removing liquid for removing bubbles which are clogging the filter to pass from one of an upstream-side piping which is connected to the processing liquid piping at an upstream side of the filter and a downstream-side piping which is connected to the processing liquid piping at a downstream side of the filter via the filter to the other of the upstream-side piping and the downstream-side piping.

8. The method for removing bubbles from a filter according to claim 7 further comprising:
prior to the removing liquid flowing,
a cleaning liquid flowing to allow a cleaning liquid for washing away the processing liquid to pass from a cleaning piping which is connected to the processing liquid piping at the upstream side or the downstream side of the filter via the filter to the other of the upstream-side piping and the downstream-side piping.

9. The method for removing bubbles from a filter according to claim 7, wherein
a flow rate of a processing liquid which passes through the filter is measured in the processing liquid flowing, and
in a case where the flow rate of the processing liquid is less than a threshold, the removing liquid flowing is executed.

10. The method for removing bubbles from a filter according to Claim 7, wherein the removing liquid flowing is executed on a regular basis.

11. The method for removing bubbles from a filter according to claim 7 further comprising:
after the removing liquid flowing,
a measurement to measure a flow rate of a liquid which passes through the filter by a flow meter; wherein
in a case where a measured value of the flow meter is less than a predetermined value, the removing liquid flowing is executed again.
